(19) United States
(12) Patent Application Publication
(10) Pub. No.: US 2005/0231393 A1
(43) Pub. Date: Oct. 20, 2005

(54) Traffic data acquistion system and method

(76) Inventors: Robert E. Berger, Huntington Beach, CA (US); Richard L. Clark, Westlake Village, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/519,901

(22) PCT Filed: Jun. 27, 2003
(86) PCT No.: PCT/US03/20085

§ 371 Date: Dec. 27, 2004

Related U.S. Application Data
(60) Provisional application No. 60/391,669, filed on Jun. 27, 2002.

(51) Int. Cl. G08G 1/123

(52) U.S. Cl. 340/995.13; 340/905

(57) ABSTRACT

A device, system, and method for providing real-time traffic information to a user is disclosed. In various embodiments, a wireless transmitter sends traffic information to a portable device that can receive and display the traffic information on a map of the display. Various roadway condition indicators may be used to convey the type and severity of roadway conditions.

### CROSS REFERENCE TO RELATED APPLICATION

This application is a continuation of co-pending U.S. Patent Application No. 60/391,669, filed Jun. 27, 2002.

### FIELD

The embodiments disclosed herein relate generally to wireless transmission of information, and more particularly to wireless transmission of traffic information to portable devices.

### BACKGROUND

Commuters in most major metropolitan areas know that freeway traffic is congested and getting worse. New freeways cannot be built fast enough to maintain even the existing levels of congestion. Traffic congestion is prevalent in the United States and in other countries, as well.

The problem of congested traffic is particularly acute for those who regularly commute during peak time periods of high-volume traffic, known as rush hour. Frequently an alternate, less congested route may be taken if a commuter is alerted in advance of a particular area of congestion. Moreover, delivery vehicles and commercial fleets can use knowledge of real-time traffic information to create efficient delivery routes that avoid highly congested traffic areas. Furthermore, some forms of public transportation (e.g., bus lines) could benefit from knowledge of current traffic conditions.

Due to the continuing severity of this problem, commuters may wish to obtain traffic information before and/or during their commute. This information is generally available from a variety of sources, including, for example, television stations, Internet websites, and radio stations. However, due to the dynamic nature of traffic conditions, the information that the commuters receive from these sources may quickly become inaccurate during their commute. However, these information sources are generally not timely and provide inadequate traffic coverage.

Moreover, various attempts have been made to provide traffic information to fixed, in-vehicle systems for use by travelers. However, these systems are restricted to in-vehicle use such that a commuter cannot access the system from a remote location (e.g., while sitting at home or in the office). This restriction can be a major disadvantage to a commuter who might change their travel plans based on traffic conditions.

For example, if a commuter is aware that a major accident has closed their travel route, they may elect to stay at home/work in order to pursue some alternative activity rather than waste time going to their vehicle to check traffic conditions. This can save a large amount of time depending on the distance and time required for some people who work in large, high-rise buildings far from where their car is parked.

Similarly, delivery vehicles, commercial fleets, and public transport vehicles can be re-routed and/or re-scheduled in order to save time and improve efficient delivery and transportation.

### DESCRIPTION OF THE DRAWINGS

Various embodiments are illustrated by way of example and not by way of limitation in the figures of the accompanying drawings in which like references indicate similar elements. It should be noted that references to “an,” “one,” “the,” “other,” “alternative,” or “various” embodiments in this disclosure are not necessarily to the same embodiment, and such references mean at least one.

FIG. 1 is one embodiment of a portable device to receive traffic information.

FIG. 2 is a side view of the device of FIG. 1 releasably disposed within a mounting device.

FIG. 3 is a block diagram illustrating one embodiment of the functional components of the device of FIG. 1.

FIG. 4 shows a wireless transmission of traffic information from a transmitter to multiple devices such as the device of FIG. 1.

FIG. 5 shows a flow chart of one embodiment of a method for a user to obtain and perceive traffic information using, for example, the system shown in FIG. 4.

### DETAILED DESCRIPTION

In the following description, for the purposes of explanation, numerous specific details are set forth in order to provide a thorough understanding of the various embodiments. It will be apparent to one skilled in the art that the embodiments may be practiced without some of these specific details. In other instances, certain structures and devices are omitted or simplified in order to avoid obscuring the details of the various embodiments.

The following description and the accompanying drawings provide examples for the purposes of illustration. However, these examples should not be construed in a limiting sense as they are not intended to provide an exhaustive list of all possible implementations.

Various methods disclosed herein can be implemented by using a machine to read instructions stored on a machine-readable medium and to perform functions in accordance with those instructions. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; and electrical, optical, acoustical or other forms of propagated signals (e.g., carrier waves, infrared signals, and digital signals).

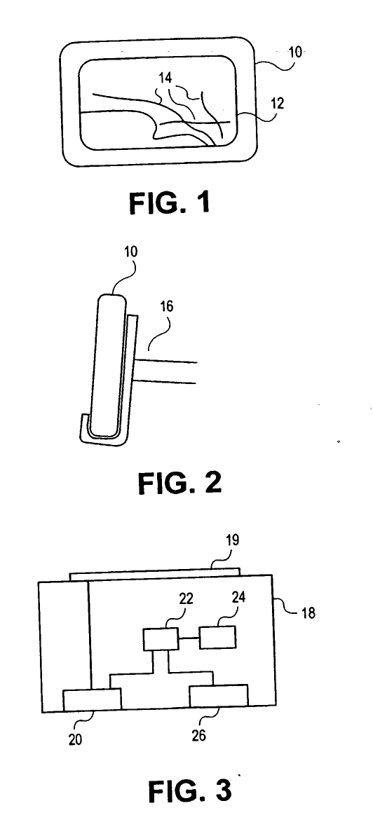

Referring now to FIG. 1, portable wireless device 10 is shown. As used herein, the term “portable” refers to the ability of a device to be removed from a vehicle and used as an independent device in any location within a broadcast area (e.g., a home, office, shopping center, etc.). The portability of the devices disclosed herein yields several advantages over devices that are fixed in a vehicle. For example, a user can view traffic information with a portable device even in locations that are remote from the vehicle. Thus, the user need not return to the vehicle every time they wish to ascertain whether traffic is at an acceptable level to suit the user's travel preferences.

Device 10 of FIG. 1 is capable of receiving traffic information from a wireless transmitter. Any suitable wireless transmission (e.g., frequency and/or protocol) can be used to send the traffic information from the wireless transmitter to device 10. For example, the wireless transmission can correspond to the following: a paging transmission, a frequency modulation (“FM”) radio transmission (e.g., including FM sub-carrier transmissions), an amplitude modulation radio transmission, a short wave radio transmission, a microwave transmission, any non-terrestrial transmission (e.g., a satellite transmission), a Wireless Application Protocol transmission, a bluetooth transmission, any type of packet-based transmission, any type of digital transmission, and any type of cellular technology, including, for example, a Global System for Mobile Communications transmission, a Time Division Multiple Access transmission, a Code-Division Multiple Access transmission, an Advance Mobile Phone Service transmission, a Personal Communications Service transmission, and a Short Message Service transmission.

The traffic information received from the wireless transmitter can be displayed on display 12. In various embodiments, display 12 is a liquid crystal display (“LCD”). In the embodiment shown in FIG. 1, display 12 includes a map on which the traffic information may be displayed. In various embodiments, the map of display 12 may be static and/or may be capable of scrolling. The map shown in FIG. 1 includes exemplary roadways 14.

Although not shown in the figures, roadways 14 may include roadway condition indicators to alert a user to the type and severity of various roadway conditions including, for example, approximate velocity of traffic traveling on a portion of a roadway, traffic accidents, construction sites, road closures, etc. These roadway condition indicators may take the form of, for example, color, an icon, a text message, or a combination of these indicators. In various embodiments, the roadway condition indicators may be used to simultaneously indicate conditions related to each direction of traffic flow on the same roadway.

Thus, different portions of a roadway may be displayed in various colors to show distinctions in the approximate speed of traffic on the different portions of the roadway. Likewise, icons can be placed at construction sites or traffic accidents. Any of these indicators may be displayed in conjunction with a text message (e.g., static or scrolling) that gives additional information regarding roadway conditions.

Device 10 may have various inputs that allow a user to manipulate the appearance of display 12 or to create a route based on historical traffic data. For example, display 12 may include icons, which are generated by software in device 10, to represent functions that device 10 is capable of performing. If display 12 is a touch screen or has an on-screen keyboard, a user may actuate the functions by pressing the screen (e.g., icons) directly or indirectly (e.g., with a stylus) or by actuating a key or button on device 10 that is associated with the icon.

In other embodiments, device 10 will have one or more keys or buttons (e.g., inputs) on device 10 that are associated with at least one function (e.g., without icons representing functions of device 10). For example, a device may include arrow keys and/or a keyboard as inputs. The user may actuate these keys or buttons to perform various functions.

In addition, device 10 may be capable of receiving inputs that are not based on physical contact. For example, device 10 may be capable of receiving input signals from a wireless keyboard, remote control, or other similar device. Moreover, device 10 may be capable of receiving vocal inputs from a user (e.g., with voice recognition software).

Regardless of the type of input used, device 10 may have various inputs available to a user. For example, a directional input may be used to display traffic conditions for a direction selected by the user. A scroll input may be used to scroll the map on display 12 (e.g., change the segment of map shown on display 12). The scroll function can be particularly useful when the user's route is so long that the map cannot display the entire route on display 12. A zoom input may be used to change the amount of territory that is shown by display 12 by zooming in or zooming out on a certain segment of the map. A color input may be used to color at least a portion of the map. A “save altered map” input may be used to save at least a portion of the map in memory (e.g., non-volatile memory) of device 10. A “set history save data” input may be used to save traffic information with a time and date associated with the saved traffic information in memory of device 10. A “create best route” input may be used to analyze, using saved traffic information and the time and date associated with the saved traffic information, the best route between a starting point and an end point and to display the best route information on display 12.

FIG. 2 shows device 10 of FIG. 1 releasably disposed within mounting device 16. Although mounting device 16 is shown as a cradle-type device, any suitable mounting configuration could be used to releasably couple device 10 to a vehicle. For example, the mounting device can allow the portable device to be secured to a vehicle's sun visor, dashboard, steering wheel, etc.

In various embodiments, device 10 can be merely mechanically coupled to a vehicle or may alternatively be also coupled to form a communications link (e.g., can be wired or wireless) between a computer (e.g., navigation system) in the vehicle and device 10. Likewise, any suitable connection (e.g., mechanical and/or for communications) can be used to connect device 10 to other types of computers (e.g., desktop computers, laptop computers, hand-held computers, single board computers, etc.), input devices, storage devices, displays, and/or other peripherals.

FIG. 3 is a block diagram illustrating one embodiment of the functional components of the device of FIG. 1. In the embodiment shown, circuit board 18 includes controller 22, communications port 20, communications port 26, memory 24, and antenna 19. In other embodiments, an internal loop is used in place of an external antenna.

In operation, antenna 19 receives a wireless transmission of traffic information, which is directed to controller 22 via communications port 20 (e.g., bi-directional communications port). Communications port 20 can contain software and/or firmware to perform various functions (e.g., displaying traffic information on a map, saving traffic information with time history data, and creating a best route). A service provider may also use the software/firmware to enable and/or disable transmissions to communications port 20.

The software and/or firmware can, in various embodiments, decode and/or decompress incoming traffic information. Once the traffic information is decoded and/or decompressed, it can be used to update and/or analyze a database associated with the portable device (e.g., located within the device or accessible by the device). The database can include any information useful for creating the display (e.g., traffic sensor locations, street/freeway locations, vehicle velocity data, etc.) After the database is updated and/or analyzed, the display can be created.

Memory 24 is coupled to controller 22 such that controller 22 may manipulate memory 24 (e.g., save, edit, and delete data) in the performance of various functions. Controller 22 is also coupled to communications port 26 in order to enable communications between device 10 and any other type of computer or electrical system.

In one embodiment, device 10 also includes a global positioning system transceiver to transmit location information to controller 22, which can be used alone or in conjunction with traffic information to navigate and/or create suggested routes for a user.

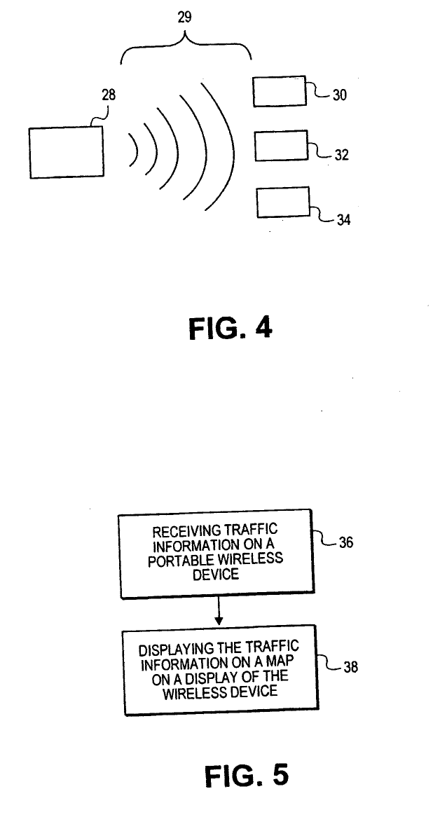

FIG. 4 shows one embodiment of a system that includes wireless transmitter 28 and portable wireless devices 30, 32, and 34. In the embodiment shown, devices 30, 32, and 34 are equivalent to device 10 of FIG. 1.

In operation, wireless transmitter 28 sends wireless transmission 29, which contains traffic information, over a coverage area. Devices 30, 32, and 34 are located within the coverage area and each receive wireless transmission 29. Devices 30, 32, and 34 may then utilize transmission 29 to display the newly received traffic information on a display in a manner perceivable by a user.

FIG. 5 shows a flow chart of one embodiment of a method for a user to obtain and perceive traffic information using, for example, the system shown in FIG. 4. At block 36, traffic information is received on a portable wireless device. The traffic information is then displayed on a map on a display of the wireless device, at block 38.

In various embodiments, the method can further include indicating a roadway condition on the map (e.g., using one of the roadway condition indicators described above). A user can also manipulate the display using the various inputs described above. Besides manipulating the appearance of the display, a user can use one or more of the inputs to save traffic information and a time and date associated with the saved traffic information. The saved traffic information and time and date associated with the traffic information can be subsequently used to create a route (e.g., best route), given a starting point and ending point. The user may also releasably couple the portable wireless device to a vehicle using any suitable mounting device.

The various portable devices disclosed herein can be used to disseminate traffic condition information to subscribing customers. A static and/or scrolling electronic map of the customer's route(s) and/or Metropolitan area can be stored in a large capacity memory medium such as a CD-ROM (e.g., a compact disc-ROM) or DVD (e.g. digital versatile disc), the memory unit of a controller such as a single-board computer, laptop computer, desktop computer, in-vehicle computer, and hand-held computing platforms, other memory locations such as flash memory and PCMCIA (e.g., Personal Computer Memory Card International Association) cards and/or within the portable device itself. Information about actual and/or potential traffic conditions can be transmitted to the portable device using any suitable wireless transmission.

The traffic information is gathered from various agencies using multiple technologies in order to create a database of traffic information. However, not all of this information may be readily available to consumers. For example, the service provider may gather traffic information from newscasts, a radio receiver scanning frequencies used by police and other emergency services, or sensors deployed on streets and highways by governmental agencies.

In various embodiments, the portable device also includes a processor (e.g., controller) for accessing the database and correlating the location of a traffic problem with a route of a subscriber. The portable device can then display a warning, and perhaps a recommended alternate route, to the subscriber.

Regardless of whether a warning is issued, the service provider can transmit traffic information compiled from the database to the subscriber. In various embodiments, the traffic information can be encoded and/or compressed before transmission to the subscriber(s).

In this manner, real-time traffic information can be provided to a subscriber 24 hours a day, 7 days a week with complete portability so that traffic information can be accessed from home, office, and in the vehicle.

In order to broadcast the traffic information, the service provider may maintain or simply utilize a network of radio transceiver base stations that are spread throughout the service area covered by the service provider. Ideally, the transmitting base stations are distributed so that the portable device can receive transmissions from at least one base station whenever the device is located within the service area. In a simplistic system, the service provider transmits traffic information from all of the base stations in the system. Thus, if the portable device is located anywhere in the service area, it will receive the transmission.

Commuters who subscribe to the service provider traffic transmission system get traffic information transmitted wirelessly to their portable device. In various embodiments, the service provider can remotely enable and/or disable the subscriber's portable device to receive and display traffic information. In one embodiment, the service provider can enable/disable each subscriber's device by sending one or more transmissions to the controller of the portable device.

In another embodiment, the service provider may send text messages to individual subscribers (e.g., regarding traffic information and/or status of subscription). In addition, the service provider may enable subscribers to send text messages directly or indirectly to another subscriber.

When traffic information arrives, the data is visually displayed in real-time to a display map for a particular metropolitan area. The incoming traffic data may then be saved in a storage medium. After being notified of any actual or potential problems along their route, each subscribing commuter may wish to circumvent congested route(s).

The commuter enters starting and ending location(s) into the portable device, and historical traffic data from the storage medium is used for analysis and prediction of alternate route guidance. The portable device can be used alone or in conjunction with an in-vehicle system, or separately with a desktop/laptop computer, handheld computing platform, or a single-board computer.

It is to be understood that even though numerous characteristics and advantages of various embodiments have been set forth in the foregoing description, together with details regarding the function of the various embodiments, this disclosure is illustrative only. Changes may be made in detail without departing from the scope of the various embodiments as expressed by the broad general meaning of the terms of the appended claims.

1. An apparatus comprising:
a portable wireless device to receive traffic information from a wireless transmitter; and
a display to display the traffic information on a map.

2. The apparatus of claim 1, wherein the traffic information corresponds to at least one of the following:
a paging transmission, a frequency modulation sub-carrier radio transmission, an amplitude modulation radio transmission, a short wave radio transmission, a microwave transmission, a satellite transmission, a Wireless Application Protocol transmission, a bluetooth transmission, a packet-based transmission, a digital transmission, a Global System for Mobile Communications transmission, a Time Division Multiple Access transmission, a Code-Division Multiple Access transmission, an Advance Mobile Phone Service transmission, a Personal Communications Service transmission, and a Short Message Service transmission.

3. The apparatus of claim 1, wherein the display comprises:
at least one of a static map and a scrolling map.

4. The apparatus of claim 1, wherein the display comprises:
a roadway condition indicator.

5. The apparatus of claim 4, comprising:
multiple roadway condition indicators, each one simultaneously relating to a different direction of traffic flow on the same roadway.

6. The apparatus of claim 4, wherein the roadway condition indicator comprises:
at least one of a color, an icon, and a text message.

7. The apparatus of claim 1, wherein the display comprises:
an input.

8. The apparatus of claim 7, wherein the input comprises:
at least one of a directional input, a scroll input, a zoom input, a color input, a “save altered map” input, a “set history save data” input, and a “create best route” input.

9. The apparatus of claim 1, further comprising:
a mounting device to releasably couple the apparatus to a vehicle.

10. The apparatus of claim 1, further comprising:
a communication port to enable communication between the apparatus and at least one of an in-vehicle computer system, a desktop computer, a laptop computer, a hand-held computer, a single-board computer, an input device, a storage device, a display, and a peripheral device.

11. A system comprising:
a wireless transmitter to transmit traffic information;
a portable wireless device to receive the traffic information from the wireless transmitter; and
a display to display the traffic information on a map.

12. The system of claim 11, wherein the traffic information corresponds to at least one of the following:
a paging transmission, a frequency modulation sub-carrier radio transmission, an amplitude modulation radio transmission, a short wave radio transmission, a microwave transmission, a satellite transmission, a Wireless Application Protocol transmission, a bluetooth transmission, a packet-based transmission, a digital transmission, a Global System for Mobile Communications transmission, a Time Division Multiple Access transmission, a Code-Division Multiple Access transmission, an Advance Mobile Phone Service transmission, a Personal Communications Service transmission, and a Short Message Service transmission.

13. The system of claim 11, wherein the display comprises:
at least one of a static map and a scrolling map.

14. The system of claim 11, wherein the display comprises:
a roadway condition indicator.

15. The system of claim 14, comprising:
multiple roadway condition indicators, each one simultaneously relating to a different direction of traffic flow on the same roadway.

16. The system of claim 14, wherein the roadway condition indicator comprises:
at least one of a color, an icon, and a text message.

17. The system of claim 11, wherein the display comprises:
an input.

18. The system of claim 17, wherein the input comprises:
at least one of a directional input, a scroll input, a zoom input, a color input, a “save altered map” input, a “set history save data” input, and a “create best route” input.

19. The system of claim 11, further comprising:
a mounting device to releasably couple the apparatus to a vehicle.

20. The system of claim 11, further comprising:
a communication port to enable communication between the apparatus and at least one of an in-vehicle computer system, a desktop computer, a laptop computer, a hand-held computer, a single-board computer, an input device, a storage device, a display, and a peripheral device.

21. A method comprising:
receiving traffic information on a portable wireless device; and
displaying the traffic information on a map on a display of the wireless device.

22. The method of claim 21, further comprising:
prior to displaying, updating a database associated with the portable device with the traffic information.

23. The method of claim 21, wherein displaying comprises:
indicating a roadway condition on the map.

24. The method of claim 23, wherein indicating comprises:
indicating multiple roadway conditions, each one simultaneously relating to a different direction of traffic flow on the same roadway.

25. The method of claim 23, wherein indicating comprises:
assigning at least one of a color, an icon, and a text message to a roadway condition to be indicated.

26. The method of claim 21, further comprising:
manipulating the display with an input.

27. The method of claim 26, wherein manipulating comprises:
actuating at least one of a directional input, a scroll input, a zoom input, and a color input.

28. The method of claim 21, further comprising:
saving traffic information and a time and date associated with the saved traffic information.

29. The method of claim 28, further comprising:
creating a route based on the saved traffic information and time and date associated with the saved traffic information.

30. The method of claim 21, further comprising:
releasably coupling the portable wireless device to a vehicle.

31. The method of claim 21, further comprising:
sending a text message to a user on a network.

32. The method of claim 21, further comprising:
transmitting the traffic information to the portable wireless device via a wireless transmission.

33. The method of claim 32, further comprising:
at least one of enabling the device to display traffic information and disabling an ability of the device to display traffic information.

34. A machine-readable medium containing instructions that, when executed by a machine, cause the machine to perform operations comprising:
receiving traffic information on a portable wireless device; and
displaying the traffic information on a map on a display of the wireless device.

35. The machine-readable medium of claim 34, wherein displaying comprises:
indicating a roadway condition on the map.

36. The machine-readable medium of claim 35, wherein indicating comprises:
indicating multiple roadway conditions, each one simultaneously relating to a different direction of traffic flow on the same roadway.

37. The machine-readable medium of claim 35, wherein indicating comprises:
assigning at least one of a color, an icon, and a text message to a roadway condition to be indicated.

38. The machine-readable medium of claim 34, wherein the operations further comprise:
altering an appearance of the display in response to actuation of at least one of a directional input, a scroll input, a zoom input, and a color input.

39. The machine-readable medium of claim 34, wherein the operations further comprise:
saving traffic information and a time and date associated with the saved traffic information.

40. The machine-readable medium of claim 39, wherein the operations further comprise:
creating a route based on the saved traffic information and time and date associated with the saved traffic information.
